(19) United States
(12) Patent Application Publication
(10) Pub. No.: US 2005/0105384 A1
(43) Pub. Date: May 19, 2005

(54) Apparatus for mixing and dispensing a multi-component bone cement

(75) Inventors: Joseph C. Eder, Los Altos Hills, CA (US); Scott McGill, San Ramon, CA (US); Mukund R. Patel, San Jose, CA (US)

Correspondence Address: Bingham McCuthen, LLP, Suite 1800, Three Embarcadero, San Francisco, CA, 94111-4067, US

(73) Assignee: Scimed Life Systems, Inc., Maple Grove, MN (US)

(21) Appl. No.: 10/716,641

(22) Filed: Nov. 18, 2003

(51) Int. Cl. B01F 13/06

(52) U.S. Cl. 366/139

(57) ABSTRACT

Apparatus for mixing and dispensing a multi-component bone cement includes a housing forming a mixing chamber, the housing having respective proximal and distal openings in communication with the mixing chamber, at least a portion of the mixing chamber extending from the proximal opening having a substantially uniform cross-section. A mixing assembly includes a rod extending into the mixing chamber and one or more mixing elements, e.g., a perforated disc or rotating blades, attached proximate a distal end of the rod, the mixing element(s) of a type such that movement of the rod relative to the housing causes the mixing element(s) to mix bone cement located in the mixing chamber. A dispensing piston has an outer periphery sized to seal the proximal opening of the mixing chamber, while allowing the piston to be moved in a distal direction through the chamber, the piston having an opening through which the rod extends, the rod having a stop fixable at a selected location along the rod for engaging and moving the piston distally through at least a portion of the mixing chamber.

### FIELD OF INVENTION

The present invention pertains to methods and apparatus for mixing and dispensing a multi-component cement, such as bone cement, for injection into a body.

### BACKGROUND

Joints and bones in the human body are often subject to degeneration as a result of disease or trauma. One way of treating this degeneration is to replace the joints or bones using artificial materials. Bone cements play a critical role in this process by acting to anchor implants into place or otherwise help in restructuring degenerated joints and bones.

Bone cements are usually comprised of a liquid monomer component that polymerizes about a polymeric powder component. Typically, the liquid monomer and powdered polymer are mixed just prior to using the bone cement because the mixed cement tends to cure rapidly. During the mixing process, the liquid monomer and powdered polymer react exothermically (i.e., producing heat) and create noxious vapors. It is desirable for the user to minimize exposure to the vapors and also to ensure that the cement is thoroughly mixed and able to be delivered quickly. In addition, precise control of the cement flow from the device is highly desirable, as it is critical to inject the proper amount of cement, and to make the injection when the cement has the proper consistency.

Various devices have been presented for the mixing and dispensing of bone cement. By way of example, U.S. Pat. No. 6,033,105 discloses an open-ended system where the cement ingredients are mixed in a container using hand-turned mixing blades. After mixing, the cement is delivered to a body location by activation of a corkscrew device that is part of the mixing mechanism. U.S. Pat. No. 6,079,868 teaches mixing and delivery of two ingredients by extruding the ingredients through a static mixing chamber. U.S. Pat. No. 6,286,670 discloses a single vessel for storing a liquid monomer and a solid polymer isolated by a barrier, which may be removed or broken for combining the ingredients to form the cement. U.S. Pat. No. 6,406,175 discloses a mixing and delivery device that is pre-packed with a polymer powder, wherein a user injects the liquid monomer into the device just prior to use. The above-referenced patents are incorporated herein for all that they teach and disclose.

### SUMMARY OF THE INVENTION

In accordance with the invention, various apparatus are provided for mixing and dispensing a multi-component cement, such as a bone cement.

In one embodiment, the apparatus includes a housing forming a mixing chamber, the housing having respective proximal and distal openings in communication with the mixing chamber, at least a portion of the mixing chamber extending from the proximal opening having a substantially uniform cross-section. A mixing assembly including one or more mixing elements, e.g., a perforated disc or rotating blades, is attached proximate a distal end of a mixing rod extending into the mixing chamber, the mixing element(s) of a type such that movement of the rod relative to the housing causes the mixing element(s) to mix bone cement components located in the mixing chamber. A dispensing piston is provided with an outer periphery sized to substantially seal the proximal opening of the mixing chamber while still allowing the piston to be moved in a distal direction through the chamber, the piston having an opening through which the mixing assembly rod extends, the rod having means for engaging the piston at a selected location along the rod proximal to the mixing element(s), such that, once the rod engages to the piston, the piston is moved distally through at least a portion of the mixing chamber by movement of the rod relative to the housing.

A sensor may be provided in position to contact bone cement being ejected through the distal housing opening. For example, the sensor may measure the mixing chamber pressure or cement temperature for purposes of controlling movement of the piston through the mixing chamber. In selected embodiments, feedback (readout) from the sensor may be an analogue or digital (e.g., numerical) display, a light indicator, a bar graph, or other visual display means. Alternately or additionally, the sensor output may be audible or vibrating.

An output valve may be provided in fluid communication with the distal opening of the housing, the valve being controllable, e.g., based at least in part on the sensor output, to divert bone cement being dispensed through the distal housing opening into one of a patient delivery lumen and a shunt lumen. The valve may be any of a number of known directional and/or relief valve types.

In one embodiment, the dispensing piston is threadably engaged with an interior wall of the housing such that the piston is moved distally through the mixing chamber in a screw-like fashion by rotation of the rod relative to the housing. In such embodiment, a safety feature may be included in which the threads of the dispensing piston slip (or “strip”) under a predetermined pressure or load to prevent the device housing and/or patient delivery tubing from a “catastrophic” failure caused by the pressure in the delivery chamber increasing as the cement starts to harden and the viscosity increases. For example, in one embodiment, a least one of the dispensing piston and interior housing wall are provided with one or more helically winding, radially protruding threads designed to strip from the respective piston or wall when pressure in the mixing chamber exceeds a predetermined amount.

In one embodiment, a barrier divides the mixing chamber into fist and second sections, with the first section containing a liquid bone cement component and the second section containing a solid bone cement component, the barrier of a type that may be broken upon the application of sufficient a force. One of the liquid and solid components may be sealed under vacuum in the respective mixing chamber section.

It may be desirable for a physician to chill the liquid bone cement component (e.g., using ice) prior to mixing in order to extend the working time of the cement. As such, embodiments of the invention can optionally include a cooling system, e.g., where cold water (or saline) is circulated through the handle and/or patient extension tubing to extend the working time of the cement. The cooling mechanism could also be a chemical reaction, incorporating something similar to an ice-pack into the injector housing, or it could be an electromechanical (e.g., battery operated) or some other type of cooling system.

In another embodiment, apparatus for mixing and dispensing a multi-component bone cement comprises a pair of connectable bodies. A first body forms a delivery chamber, the first body having respective proximal and distal openings in communication with the delivery chamber, at least a portion of the delivery chamber extending from the proximal opening having a substantially uniform cross-section. A dispensing assembly including a dispensing piston attached to a distal facing end of a dispensing rod extends into the delivery chamber through the proximal opening, the dispensing piston having an outer periphery sized to substantially seal the proximal opening of the delivery chamber, while allowing the dispensing piston to be moved distally through the delivery chamber by movement of the dispensing rod relative to the first body. A second body forms a mixing chamber. An intra-chamber valve is provided for selectably placing the mixing chamber in communication with the delivery chamber when the second body is connected to the first body.

In one embodiment, the dispensing piston is threadably engaged with an interior wall of the first body such that the piston is moved distally through the delivery chamber in a screw-like fashion by rotation of the dispensing rod relative to the first body.

The second body may come pre-filled with the bone cement ingredients (e.g., separated by a barrier), or just one of a liquid or solid component. By way of non-limiting example, the solid components of a bone cement can be pre-filled in the mixing chamber, with the liquid components injected through a membrane just prior to use.

In one embodiment, a mixing cartridge is sized to fit into the mixing chamber, the cartridge having a sealable opening positioned to be in communication with the intra-chamber valve when the cartridge is placed in the mixing chamber and the second body is attached to the first body.

In embodiments of the invention, the patient delivery tube may be permanently fixed to the housing. By way of one example, the device housing and patient delivery tube may be formed by a single-mold manufacturing process, e.g., having a single body construction. An advantage of having a permanently affixed patient delivery tube is that it reduces the number of steps required by the physician to operate the device, and allows for reduced pressure drop in the cement delivery system by reduction in the transitions between the delivery chamber and the tubing. It further reduces the risk of leaks at this junction point.

Other and further aspects, features and embodiments of the invention will be evident from reading the following detailed description of the preferred embodiments, which are intended to illustrate, not limit, the invention.

### BRIEF DESCRIPTION OF THE DRAWINGS

The drawings illustrate the design and utility of preferred embodiments of the invention, in which similar elements are referred to by common reference numerals, and in which:

FIGS. 1A and 1B are cut-away, elevated side views of a first embodiment of a bone cement mixing/dispensing device, according to one aspect of the invention.

FIG. 2 is a cut-away, elevated side view of a second embodiment of a bone cement mixing/dispensing device, according to another aspect of the invention.

FIG. 3 is a cut-away, elevated side view of a further embodiment of a bone cement mixing/dispensing device, according to yet another aspect of the invention.

FIG. 4 is a cut-away, elevated side view of a further embodiment of a bone cement mixing/dispensing device, according to yet another aspect of the invention.

FIGS. 5A and 5B are cut-away, elevated side views of a still further embodiment of a bone cement mixing/dispensing device, according to yet another aspect of the invention.

FIGS. 6A and 6B are cut-away, elevated side views of a separate mixing cartridge that may be optionally used with a bone cement mixing/dispensing device, according to still another aspect of the invention.

### DETAILED DESCRIPTION OF THE ILLUSTRATED EMBODIMENTS

Various embodiments of the present invention are described hereinafter with reference to the figures. It should be noted that the figures are not drawn to scale and that elements of similar structures or functions are represented by like reference numerals throughout the figures. It should also be noted that the figures are only intended to facilitate the description of specific embodiments of the invention, and are not intended as an exhaustive description, or as a limitation on the scope, of the invention. Aspects, features, and advantages described in conjunction with a particular embodiment are not necessarily limited to that embodiment and may be practiced with other embodiments of the invention, even if not so illustrated or specifically described.

Further, while the inventive concepts and devices are shown and described herein for the purpose of mixing and dispensing of bone cements, such as PMMA bone cements, other types of biomaterials, e.g., ceramics, such as calcium aluminate, calcium, phosphate, calcium sulfate, etc., can also be mixed and dispensed by the apparatus of the invention.

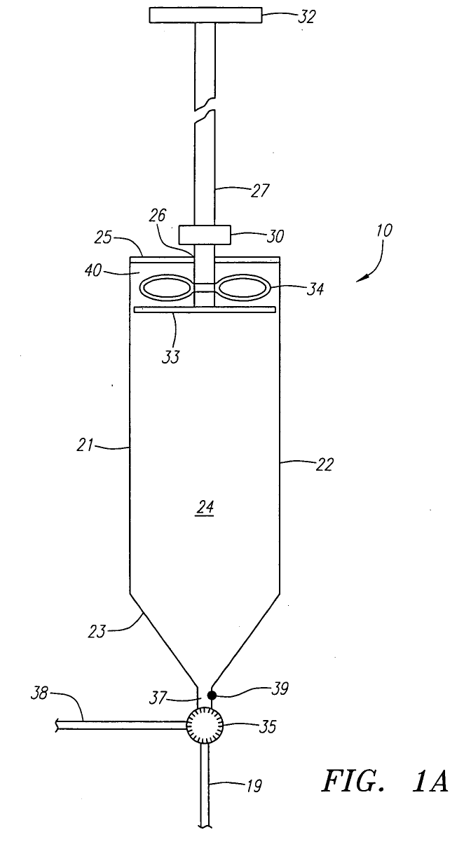

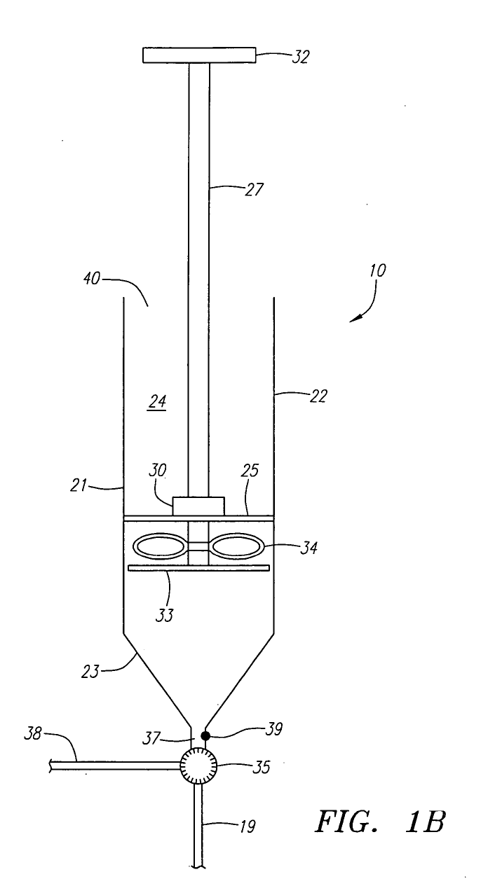

FIGS. 1A and 1B depict a device 10 for mixing and dispensing bone cement to a cannula (not shown) inserted in a selected body (i.e., bone) cavity (also not shown). The device 10 includes a tubular body 21 having a proximal portion 22 and a tapered distal portion 23, and forming an internal mixing chamber 24. The tapered distal portion 23 has a narrow opening 37 in communication with the mixing chamber 24. The tubular body 21 also has a proximal opening 40, sealed by a movable ejection piston 25. In particular, the ejection piston 25 has an outer circumference sized to snuggly fit in the inner circumference of the proximal portion 22 of the tubular body 21. A gasket, or other type of sealing means (not shown) may be disposed about the periphery of the piston 25 to prevent the cement contents in the chamber 24 from passing between the piston 25 and internal wall of the tubular body 21. In an alternate embodiment, a separate (preferably removable) cover may be provided to seal the proximal opening 40 and the chamber 24 separate from the ejection piston 25.

The piston 25 has a central opening 26 through which a rod 27 extends into the chamber 24. A handle 32 is attached to the proximal end of the rod 27. Again, a gasket or other sealing means (not shown) is provided around the circumference of opening 26, such that the rod 27 moves slidably there through, in order to provide a seal between the chamber 24 and the external atmosphere. Preferably, the rod 27 fits snuggly through the opening 26, but is movable relative to the tubular body 21 without a user having to exert undue force. In alternate embodiments, the rod 27 may be fixed to the piston 25, or a latch mechanism (not shown) may be employed to allow the user to selectively fix the rod 27 to the piston 25.

In the illustrated embodiment, a stop ring 30 is selectively placed around the rod 27 to limit the distance that the rod 27 may be extended into the chamber 24. Preferably, a user of the device 10 may fix the stop ring 30 at a desired position along the length of the rod 27, although it may also be fixed to begin with. By way of non-limiting example, the stop ring 30 may be compliant and snuggly, but movably, stretched around about the rod 27. Alternately, the stop ring 30 may be fixed to the rod 27 using a locking screw. As is illustrated in FIG. 1B, as the rod 27 is moved relative to the tubular body 21 and into the chamber 24, the stop ring 30 engages the piston 25, causing the piston 25 to be moved into the chamber 24 along with the rod 27.

In accordance with a main aspect of the invention, a perforated mixing disc 33 is attached to the distal end of the rod 27. As the disc 33 is moved through the chamber 24, the contents in the chamber 24 are passed through the perforations (not shown) in the disc 33 and mixed. As will be appreciated by those skilled in the art, the size of the perforations in the disc 33 may vary, and should be selected based on achieving the proper balance between being small enough to adequately mix the contents in the chamber 24, while being large enough to allow forward movement of the piston 25 without undue exertion on the part of the user, and without causing the seals around the respective perimeters of the piston 25 and rod 27 to fail. As will also be further appreciated, for the same reasons, the outer circumference of the mixing disc 33 may be varied, such that the disc 33 extends radially for up to all of the inner diameter of the proximal portion of the tubular body 21. It may be desirable in embodiments of the invention to add one or more static mixing elements, e.g., in the mixing chamber and/or in the delivery tubing (discussed below).

In the illustrated embodiment, a mixing impeller 34 is rotatably attached to the rod 27 between the ejection piston 25 and the mixing disc 33 to further facilitate mixing of the contents of the chamber 24. By way of non-limiting example, the impeller may comprise a plurality of angled mixing blades attached to a rotating collar on the rod 27, so that the blades are rotated around the rod 27 by force of the contents of the chamber 24 against the blades, as the impeller 34 is moved through the chamber 24. It will be appreciated that alternate embodiments of the invention may be provided with only one of the perforated mixing disc 33 and impeller 34.

A directing valve 35 is located at the distal opening 37 on the tubular body 21. In the illustrated device 10, the valve 35 is a three-way valve, which seals off the opening 37 in a first position; directs cement product extruded from the chamber 24 to a patient delivery tube 19 in a second position; and diverts the cement product extruded from the chamber 24 to a shunt relief tube 38 in a third position. The valve 35 may be manually or automatically controlled. An automatically controlled valve 35 may be controlled by any number of means, including a mechanical, hydraulic or electrical means. For example, the valve 35 may be controlled by an automatic means such that when the ejection disc 25 starts or stops moving in the lumen 24, the valve 35 is activated. While the respective shunt and delivery tubes 38 and 19 may be removably attachable to the distal opening 37, in one embodiment of the invention, the delivery tube 19 is permanently fixed to the tubular body 22, in at least one embodiment, the delivery tube 19 is permanently fixed to the body 22. For example, the body 22 and delivery tube 19 may be constructed using a single body injection mold, or other known manufacturing process. Alternately, they may be attached using a plastic welding process or adhesive bonding element.

In the illustrated device 10, a sensor 39 is provided proximate the cement extrusion opening 37, and may be used to control the valve 35 based on properties of the cement product in the chamber 24. For example, the sensor 39 could be a pressure gage that could tell the user when the compound in the lumen 24 is at a desired functional viscosity for patient delivery, in which case the valve 35 is moved to the second position to direct the cement into the patient tube 19; or if the viscosity is too great—i.e., signaling the cement has hardened beyond the point of safe delivery to the patient, in which case the valve 35 is moved to the third position to divert the cement into the shunt tube 38. By way of another, non-limiting, example, the sensor 39 could measure the temperature of the cement mixture in the chamber and, based on the known exothermic nature of the cement mixture, control the valve 35 for delivery to either the patient tube 19 or shunt tube 38, according to the temperature of the cement. In selected embodiments (not illustrated), feedback (readout) from the sensor may be an analogue or digital (e.g., numerical) display, a light indicator, a bar graph, or other visual display means. Alternately or additionally, the sensor output may be audible or vibrational.

In addition to relieving internal pressures when the plunger mechanism stops applying force, the shunt relief line 38 can also be designed to divert flow (and relieve pressure) at a maximum allowable pressure in the chamber 24. For example, the valve 35 may be automatically actuated to divert the cement flow to the shunt relief 38 at a given pressure in chamber 24 in order to prevent device failure, i.e. where the device breaks into piece due to the extremely high chamber pressure.

This type of pressure relief is also useful as a mechanical method of determining the optimal cement properties for injecting into the patient line 19. In particular, as the cement cures, the pressure inside the chamber 24 increases significantly, and the force required to inject the cement increases concurrently. Thus, if the cement gets too hard, the high pressure sensed by the sensor 39 may actuate a visual indicator (not shown) to the operator that the cement has cured and can no longer be safely injected into the patient. Because the pressure is also a function of how fast the operator advances the ejection piston 25: if the operator depress the piston 25 too quickly, the pressure will spike, and the valve 35 may be controlled to direct the cement into the shunt line 38 upon a maximum allowable pressure in the chamber 24 being sensed by sensor 39, in order to prevent the operator from injecting cement into the patient too quickly.

Because it is undesirable for the device 10 to burst or break into pieces while injecting cement, it may be desirable to incorporate a controlled failure mode. In particular, as the pressure increases in the delivery chamber, the torque on the piston 25/rod 27/handle 32 increases. A controlled failure mode can be designed in to these components so that they “fail” (i.e., stop driving the piston 25) at a known torque reached before pressure inside the chamber 24 approaches a certain maximum pressure.

Another feature of the mixing/dispensing device 10 is that the components of the bone cement may be inserted by the user into, or come “pre-packaged” in, the chamber 24 of tubular body 21. For example, the components can be inserted into the mixing chamber 24 (with or without any pre-mixing) by the user through the proximal opening 40 by removal of the ejection piston assembly. Alternatively, some or all of the cement components may be pre-packaged in the chamber 24. For example, a solid component of the bone cement may be pre-packaged in the chamber 24 by the manufacturer, with a liquid component to be added by the user.

To operate the mixing/dispensing device 10, all ingredients of the cement must be present in the chamber 24. Thereafter, the opening 40 at the proximal end 22 is sealed by the ejection piston assembly (rod 27, piston 25, mixing disc 33 and/or impeller 34). The user mixes the ingredients together by moving the rod 27 back-and-forth relative to the tubular body 21, thereby employing one or both mixing implements 33 and 34. Notably, the ejection piston 25 is preferably left in a position about he proximal opening 40, with the stop ring 30 disengaged, during the mixing, so as to prevent premature expulsion of the cement contents from the chamber 24. By way of example, this may be accomplished by providing a latch that holds the piston 25 in place while the ingredients are being mixed.

In an alternate embodiment, the ejection piston assembly (rod 27, piston 25, mixing disc 33 and/or impeller 34) may be threaded into the interior wall of the tubular body 22, i.e., such that the piston assembly is moved distally through the chamber 24 by rotating the handle 32 to cause the mixing implement(s) 33 and/or 34 to move through the chamber 24 in a screw-like fashion. This embodiment may have the advantage of more precisely controlled ejection of the mixed cement from the chamber 24.

The user may additionally or alternatively employ manual shaking of the device 10 as part of the mixing process, if so desired. Notably, most known bone cements have a specific set up and cure time, so it is very important that the liquid component(s) of the cement are not mixed with the solid component(s) until just prior to use. Once the ingredients are thoroughly mixed, and the cement has cured to a desirable set point, the user fixes the stop ring 30 in a selected position along the rod 27, as shown in FIG. 1A, and depresses to allow the disc 25 to expel the product out of the opening 37 on the distal end 23 of the tubular body 21, as shown in FIG. 1B.

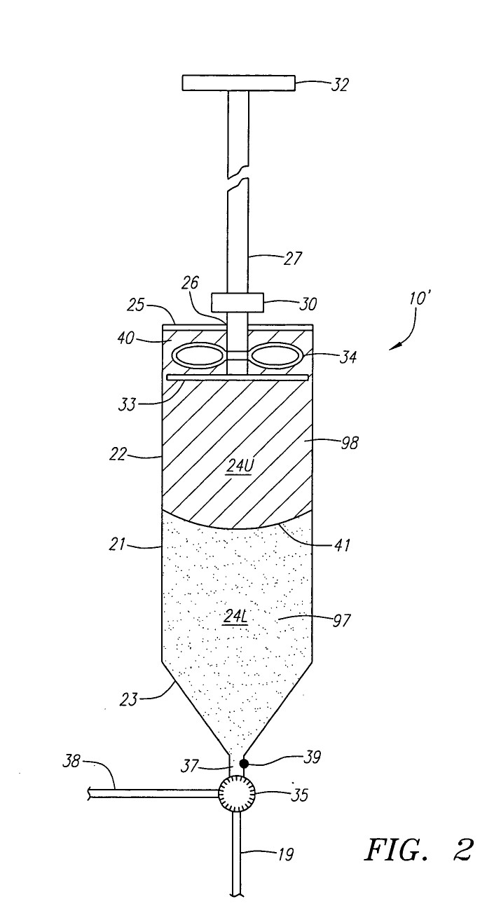

Alternatively, as shown in device 10′ of FIG. 2, both a solid component and a liquid component of a bone cement may be pre-packaged by the manufacturer in the chamber 24. The pre-packed solid and liquid components must be separated from each other until mixing by a physical barrier 41, which divides the chamber 24 into two sub chambers. This barrier 41 may consist of plastic or another material that would rupture when moderate force is applied by the user. Preferably, the barrier 41 is made of a material that is easily breakable and non-reactive to the components—individually or the product of the mixture of the components. In addition, one of the components could be placed under a slight vacuum when sealed in order to aid in the mixing of the components. For example, the solid component could be placed under a vacuum so that, when the barrier 41 is ruptured, the liquid component is immediately drawn into the solid component.

Once the barrier is ruptured, the process of mixing and delivery in device 10′ is substantially the same as described above for device 10 in FIGS. 1A and 1B.

It is important that a total and thorough mix of the cement ingredients takes place. Preferably, the tubular body 21 is made out of a transparent or a semi-transparent material, in order to allow the operator to visualize the mixing, transfer, and delivery of the cement in and from chamber 24t, and also to allow the operator to identify the presence of any air bubbles in the cement mix.

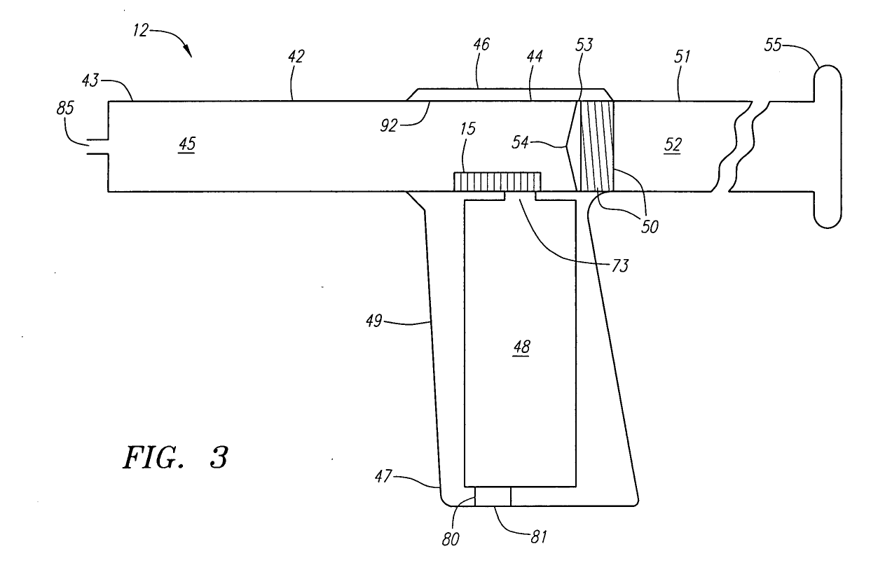

A further embodiment of a mixing and delivery device 12 is shown in FIG. 3. The device includes a first, tubular body 42 having a proximal end 43, a distal end 44, and forms a delivery chamber 45. The first body 42 is connected to a second body 49, the second body having a proximal end 46, a distal end 47, and forms a mixing chamber 48. Although any of a number of attachment mechanisms may be employed, in the illustrated device 12, the distal end 46 of the second body 49 forms a lumen 92, which is isolated from the mixing chamber 48 and sized for receiving the tubular first body 42 there through. The second body 49 may be connected to the first body 42 at any desired angle or in any mechanical relationship, so long as the delivery chamber 45 and mixing chamber 48 are in fluid communication with each other. In particular, an opening 73 in the mixing chamber 48 accesses the delivery chamber 45 through a valve 15, wherein the valve 15 may be switched between a first position which isolates the mixing chamber 48 from the delivery chamber 45, and a second position which places the respective chambers 45 and 48 in fluid communication.

In the illustrated device 12, the proximal end 46 of body 49 is connected to the distal end 44 of body 42 at an angle of slightly more than 90 degrees, i.e., resembling a pistol. This arrangement allows the second body 49 to be used as a “handle” to conveniently hold the device 12 during use. The proximal end 43 of the first body 42 has a cement extrusion opening 85 in communication with the delivery chamber 45. Connected to opening 85 (i.e., external to the device 12) may be the same valve and shunt tube assembly (35, 38, 19) shown in use with device 10 in FIG. 1. In addition, a sensor-such as sensor 39 of device 10—may also be used for controlling the output of device 12.

The distal 44 end of body 42 has an opening 50 sealed by a plunger 51. The plunger 51 consists of a rod 52 and a piston disc 53 connected to a distal end of the rod 52. The plunger 51 also has a handle 55 attached to the proximal end of the rod 52. The disc 53 preferably fits snuggly—but slidably—within the inside wall of the body 42, forming a movable seal to the delivery chamber 45. For example, a soft gasket (not shown) may be provided around the exterior circumference of the disc 53. The rod 52 has a sufficient length so that the disc 53 may be moved through the delivery chamber 45 and pressed against the (interior) distal end of the tubular body 42. The distal facing surface of the disc 53 is preferably slightly tapered, such that a raised portion 54 can extend into the opening 85.

In one embodiment, the plunger 51 is threaded into the interior wall of the tubular body 42, i.e., such that the plunger 51 is moved distally through the delivery chamber 45 by rotating the handle 55 to cause the plunger 51 to move along the threaded wall of the delivery chamber 45 in a screw-like fashion. This embodiment may have the advantage of more precisely controlled movement of the plunger 51 through the chamber 45.

An opening 80 is provided in the distal end 47 of the second body 49 for accessing the mixing chamber 48. A plug 81 seals the opening 80, the plug 81 being made of a material, e.g., silicon or rubber, that allows a needle to be inserted through the plug 81. In this manner, the chamber 48 can be pre-filled (e.g., by the manufacturer) with the solid component(s) of a cement to be mixed in the chamber 48. With the valve 15 in a “closed” (i.e., isolating) position, the user injects the liquid component into the chamber by piercing the plug 81 with a syringe containing the liquid cement component(s), and dispensing the liquid into the chamber 48. To mix the solid and liquid components together, the device 12 is shaken by the user.

After mixing the components together, the device 12 is inverted (with reference to FIG. 3), and—with the disc 53 moved proximal to opening 73, the valve 15 is switched to an open position. This allows the mixed cement product to flow from the mixing chamber 48 into the delivery chamber 45. Once the cement product is in the delivery chamber 45, the switch 10 is moved back to a closed position, and the device 12 is turned upright. The user can then dispense the mixed cement product through opening 85 by moving the plunger 51 distally through the delivery chamber 45. In alternate embodiments, the plunger 51 may be moved using a mechanical means such as a screw device (not shown). The movement may be controlled manually by the user, or could be controlled automatically.

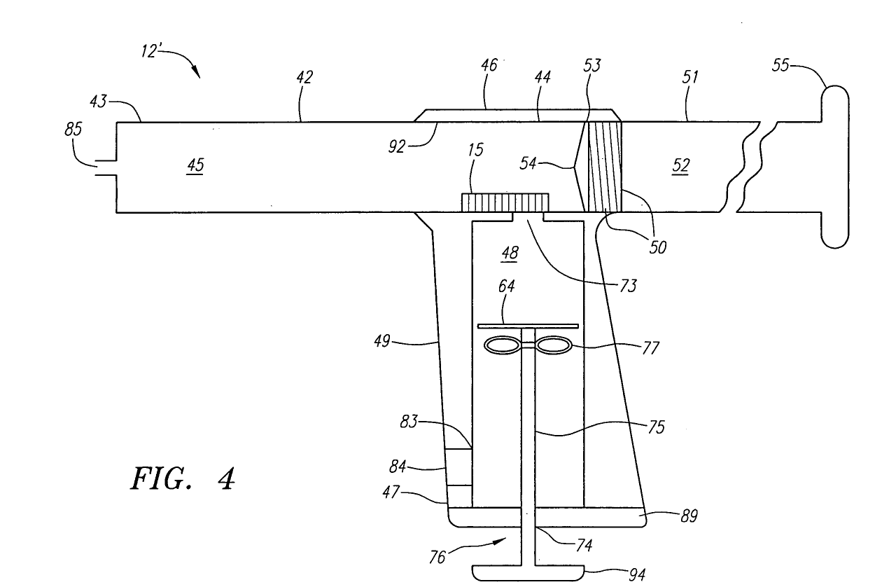

A variation of device 12 (referenced as 12′) is shown in FIG. 4, which has the same features as device 12 of FIG. 3, with the addition of a mixing disc assembly 76 similar to the disc assembly (27/34/33) of FIG. 1A inserted through the distal end of the second body 49 and extendable through the mixing chamber 48. In particular, the device distal end 47 of the second body 49 in device 12′ is provided with a gasket cap 89 with a central opening 74 through which a rod 75 extends into the mixing chamber 48. A handle 94 is attached to a proximal end of the rod 75. Again, a gasket or other sealing means (not shown) is preferably provided around the circumference of opening 74, such that the rod 75 moves slidably there through, in order to seal the chamber 48. Preferably, the rod 75 fits snuggly through the opening 74, but is movable relative to the body 49 without a user having to exert undue force.

A perforated mixing disc 64 is attached to the distal end of the rod 75. As the disc 64 is moved through the chamber 48, the contents in the chamber 48 are passed through the perforations (not shown) in the disc 64 and mixed. The size of the perforations in, and the outer circumference of, the mixing disc 33 may be varied, with these dimensions selected based on achieving the proper balance between adequately mixing the contents in the chamber 48, while allowing forward movement of the disc 64 without undue exertion on the part of the user. In the illustrated embodiment, a mixing impeller 77 is rotatably attached to the rod 75 just proximate (beneath) the mixing disc 64 to further facilitate mixing of the contents of the chamber 48. As with impeller 34 in the device 10 of FIG. 1A, the impeller 77 may comprise a plurality of angled mixing blades attached to a rotating collar on the rod 75, so that the blades are rotated around the rod 75 by force of the contents of the chamber 48 against the blades as the impeller 77 is moved through the chamber 48. It will be appreciated that alternate embodiments of the invention may be provided with only one of the perforated mixing disc 64 and impeller 77.

An opening 83 sealed with a plug 84 is provided in the side of the body 49, proximate distal end 47, for accessing the mixing chamber 48. The plug 84 is made of a material, e.g., silicon or rubber, that allows a needle to be inserted through the plug 84. In this manner, the chamber 48 can be pre-filled (e.g., by the manufacturer) with the solid component(s) of a cement to be mixed in the chamber 48. With the valve 15 in a closed position, the user injects the liquid component into the chamber by piercing the plug 84 with a syringe containing the liquid cement component(s), and dispensing the liquid into the chamber 48. Alternately or additionally, the user may remove the cap 89 and mixing assembly 76 in order to place the components to be mixed into the chamber 48. Mixing is accomplished by moving the rod 75 with the mixing devices 64 and 77 through the chamber 48. To facilitate mixing the solid and liquid components together, the device 12′ may be shaken by the user. Once the product is mixed, operation of the device 12′ is substantially the same as for the device 12 shown in FIG. 3.

Again, it is preferable that the respective bodies 42 and 49 are made out of a transparent or a semi-transparent material, in order to allow the operator to visualize the mixing, transfer, and delivery of the cement in and from chambers 48 and 45, as well as to allow the operator to identify the presence of any air bubbles in the cement mix.

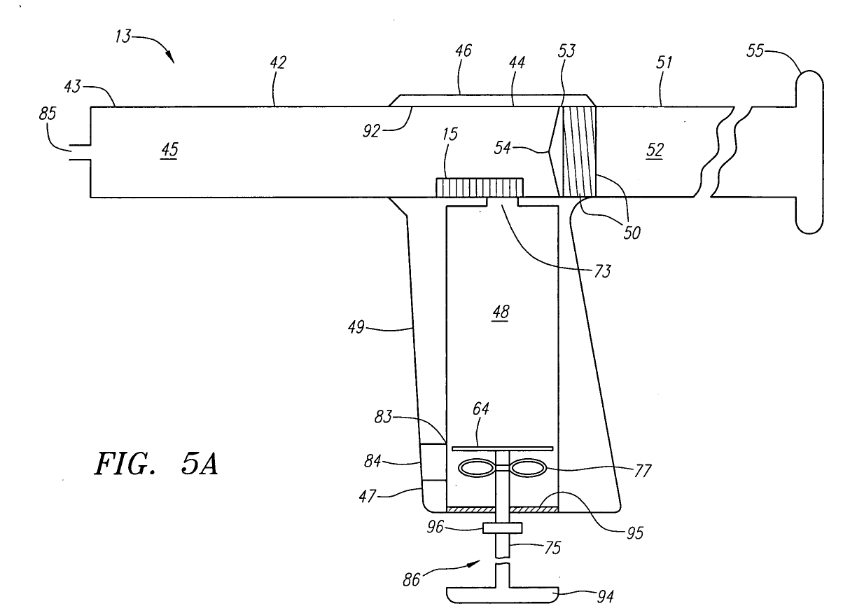

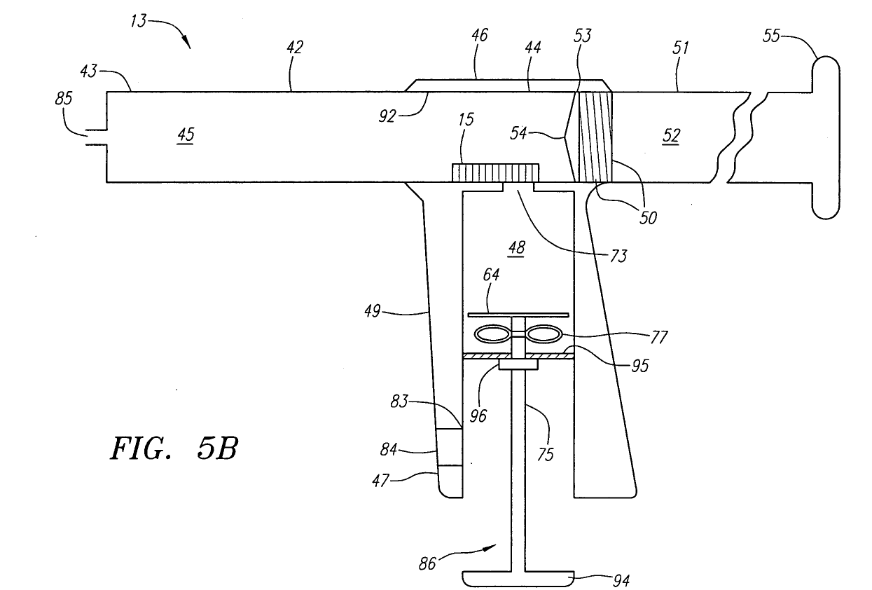

FIGS. 5A and 5B illustrate yet another mixing and delivery device 13 constructed in accordance with yet another aspect of the invention, which combines the features of device 12′ of FIG. 4, with the movable dispensing piston/disc of device 10 of FIGS. 1A and 1B. In particular, the distal end cap 89 of device 12′ is removed, and the mixing assembly 76 is replaced with a combined mixing and dispensing assembly 86 in device 13, in which the distal opening of body 49 is sealed by a movable ejection piston 95. The ejection piston 95 has an outer circumference sized to snuggly fit in the inner circumference of the chamber 48. A gasket, or other type of sealing means (not shown) may be disposed about the periphery of the piston 95 to prevent the cement contents in the chamber 48 from passing between the piston 95 and chamber wall. In an alternate embodiment, a separate (preferably removable) cover may be provided to seal the chamber 48 separate from the ejection piston 95.

The piston 95 has a central opening through which rod 75 extends into the chamber 48. Again, a gasket or other sealing means (not shown) is preferably provided around the circumference of opening in piston 95, such that the rod 75 moves slidably there through, in order to maintain the sealing of chamber 48. Preferably, the rod 75 fits snuggly through the opening in piston 95, but is movable relative to body 49 without a user having to exert undue force. In alternate embodiments, the rod 75 may be fixed to the piston 95, or a latch mechanism (not shown) may be employed to allow the user to selectively fix the rod 75 to the piston 95.

In device 13, a stop ring 96 is selectively placed around the rod 75 to limit the distance that the rod 75 may be extended into the chamber 48. Preferably, a user of the device 13 may fix the stop ring 96 at a desired position along the length of the rod 75, although it may also be fixed to begin with. By way of non-limiting example, the stop ring 96 may be compliant and snuggly, but movably, stretched around about the rod 75. Alternately, the stop ring 96 may be fixed to the rod 75 using a locking screw. As is illustrated in FIG. 1B, as the rod 75 is moved relative to body 49 and into chamber 48, the stop ring 96 engages piston 95, causing piston 95 to be moved through chamber 48 along with the rod 75. Obviously, the valve 15 must be opened prior to movement of the piston 95, or compression of the contents in chamber 48 would either prevent movement, or break the seal formed through piston 95.

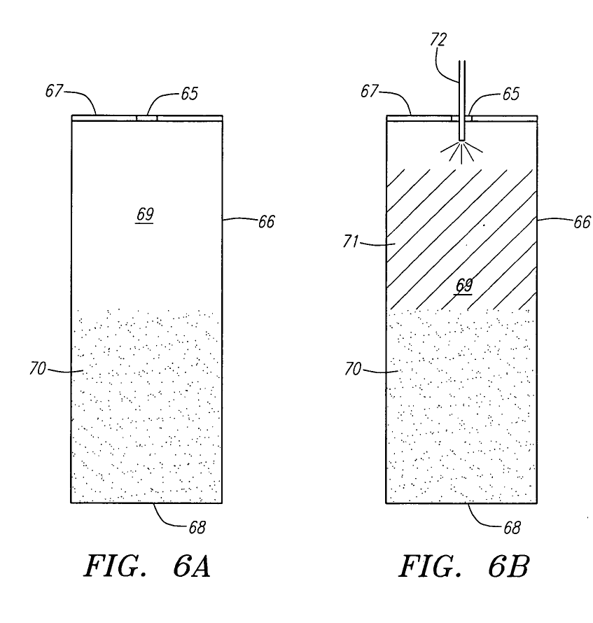

Referring now to FIGS. 6A and 6B, in accordance with yet another aspect of the invention, a removable mixing cartridge 66 may be optionally used in conjunction with a delivery device, such as devices 12, 12′ or 13 shown in FIGS. 3, 4 and 5A-B. It will be apparent the minor modifications to the mixing body 49 may be made in order to accommodate the cartridge 66, which is sized to fit in chamber 48, e.g., in a snap-in locking arrangement. The cartridge forms a sealed chamber 69, which is pre-filled with the solid component(s) 70 of a bone cement. A first end 67 of the cartridge 66 is provided with a sealed opening 65, through which a needle 72 can be inserted to inject the liquid bone cement component(s) 71. After the liquid components(s) 71 are added, the cartridge 66 is shaken (not stirred), to mix the cement ingredients. The cartridge 66 is then inserted into the second body 49 (i.e., through the distal opening in place of the mixing assembly 76 or 86). The same opening 65 used to insert the liquid cement components 71 into chamber 69 may be aligned with the opening of the valve 15 for communication of the cement contents into the delivery chamber 45. Alternatively, access may be had through an opposite end 68 of the cartridge 66.

As will be apparent, in alternate embodiments, both of the solid and liquid cement components 70 and 71 may be pre-placed in the cartridge 66, e.g., with a barrier isolating the ingredients until the cartridge is sufficiently shaken to break the barrier. As will also be apparent, the mixing assembly 76 or the mixing and dispensing assembly 86, or some variation thereof, be employed after the cartridge 66 is placed in the body 49, as described above.

Although preferred embodiments of the invention are shown and described herein, it would be apparent to those skilled in the art that many changes and modifications may be made thereto without the departing from the scope of the invention, which is defined by the following claims.

1. Apparatus for mixing and dispensing a multi-component bone cement, comprising:
a housing forming a mixing chamber, the housing having respective proximal and distal openings in communication with the mixing chamber, at least a portion of the mixing chamber extending from the proximal opening having a substantially uniform cross-section;
a mixing assembly including a rod extending into the mixing chamber from the proximal housing opening, and a mixing element attached to the rod proximate a distal end of the rod, the mixing element of a type such that movement of the rod relative to the housing causes the mixing element to mix bone cement located in the mixing chamber; and
an dispensing piston having an outer periphery sized to substantially seal the proximal opening of the mixing chamber while allowing the piston to be moved distally through the mixing chamber, the piston having an opening through which the rod extends into the mixing chamber.

2. The assembly of claim 1, wherein the dispensing piston is threadably engaged with an interior wall of the housing such that the piston is moved distally through the mixing chamber in a screw-like fashion by rotation of the rod relative to the housing.

3. The assembly of claim 2, at least one of the dispensing piston and interior housing wall having one or more helically winding, radially protruding threads designed to strip from the respective piston or wall when pressure in the mixing chamber exceeds a certain amount.

4. The assembly of claim 1, further comprising an integrated cooling system for cooling the mixing chamber.

5. The assembly of claim 1, the mixing element comprising a perforated disc.

6. The assembly of claim 1, the mixing element comprising one or more rotatable blades.

7. The assembly of claim 1, the mixing assembly comprising a plurality of mixing elements attached to the rod proximate the rod distal end, each mixing element of a type such that movement of the rod relative to the housing causes the mixing element to mix bone cement components located in the mixing chamber.

8. The assembly of claim 7, wherein a first mixing element comprises a perforated disc and a second mixing element comprises a plurality of rotatable blades.

9. The assembly of claim 8, wherein the perforated disc is attached to the rod distally to the plurality of rotatable blades.

10. The assembly of claim 1, further comprising a sensor positioned at or near the distal housing opening to contact bone cement being dispensed there through, the sensor having an output signal.

11. The assembly of claim 10, wherein movement of the piston through the mixing chamber is controlled at least in part based on the sensor output signal.

12. The assembly of claim 10, wherein the sensor output signal is indicative of a pressure in the mixing chamber.

13. The assembly of claim 10, wherein the sensor output signal is indicative of a temperature of the bone cement.

14. The assembly of claim 10, further comprising an output valve in fluid communication with the distal housing opening, the valve controllable based at least in part on the sensor output signal to divert bone cement being dispensed from the chamber into one of a patient delivery lumen and a shunt lumen.

15. The assembly of claim 1, further comprising an output valve in fluid communication with the distal housing opening, the valve controllable to divert bone cement being dispensed from the chamber into one of a patient delivery lumen and a shunt lumen.

16. The assembly of claim 1, further comprising a stop selectively positioned on the rod for engaging and moving the piston as the rod is moved distally through the mixing chamber.

17. The assembly of claim 16, the stop comprising an elastic ring that forms an interference fit around the rod.

18. The assembly of claim 16, the stop comprising a locking member that may be fixed to the rod with a screw.

19. The assembly of claim 1, further comprising a barrier dividing the chamber into fist and second isolated sections, the first section containing a liquid bone cement component, and the second section containing a solid bone cement component, the barrier of a type that may be broken upon the application of a sufficient force.

20. The assembly of claim 19, wherein one of the liquid and solid components is sealed under vacuum in the respective mixing chamber section.

21. The assembly of claim 1, further comprising a patient delivery tube in fluid communication with the mixing chamber, the patient delivery tube being permanently fixed to the housing.

22. The assembly of claim 21, wherein the housing and patient delivery tube are formed as a single body structure.

23. The assembly of claim 1, further comprising a patient delivery tube in fluid communication with the mixing chamber, and an integrated cooling system for cooling one or both of the mixing chamber and patient delivery tube.

24. Apparatus for mixing and dispensing a multi-component bone cement, comprising:
a first body forming a delivery chamber, the first body having respective proximal and distal openings in communication with the delivery chamber, at least a portion of the delivery chamber extending from the proximal opening having a substantially uniform cross-section;
a second body connectable to the first body, the second body forming a mixing chamber;
an intra-chamber valve for selectably placing the mixing chamber in communication with the delivery chamber when the second body is connected to the first body; and
a dispensing assembly including a dispensing piston attached to a distal facing end of a dispensing rod extending into the delivery chamber through the proximal opening, the dispensing piston having an outer periphery sized to substantially seal the proximal opening of the delivery chamber, while allowing the dispensing piston to be moved distally through the delivery chamber by movement of the dispensing rod relative to the first body.

25. The assembly of claim 24, wherein the dispensing piston is threadably engaged with an interior wall of the first body such that the piston is moved distally through the delivery chamber in a screw-like fashion by rotation of the dispensing rod relative to the first body.

26. The assembly of claim 25, at least one of the dispensing piston and interior first body wall having one or more helically winding, radially protruding threads designed to strip from the respective piston or wall when pressure in the delivery chamber exceeds a certain amount.

27. The assembly of claim 24, further comprising an integrated cooling system for cooling the mixing chamber.

28. The assembly of claim 24, the second body having an opening for accessing the mixing chamber

29. The assembly of claim 28, the second body opening comprising a sealing membrane that may be pierced by an injection needle.

30. The assembly of claim 29, the mixing chamber being filled with solid components of a bone cement.

31. The assembly of claim 28, further comprising a mixing cartridge sized to fit into the mixing chamber through the second body opening, the cartridge having a sealable opening positioned to be in communication with the intra-chamber valve when the cartridge is placed in the mixing chamber and the second body is attached to the first body.

32. The assembly of claim 24, further comprising a mixing assembly including a mixing rod having a distal end extending into the mixing chamber, and a mixing element attached to the mixing rod distal end, the mixing element of a type such that movement of the mixing rod relative to the second body causes the mixing element to mix bone cement located in the mixing chamber.

33. The assembly of claim 32, the mixing element comprising a perforated disc.

34. The assembly of claim 32, the mixing element comprising one or more rotatable blades.

35. The assembly of claim 24, further comprising a sensor positioned at or near the distal opening of the first body to contact bone cement being dispensed there through, the sensor having an output signal.

36. The assembly of claim 35, wherein movement of the dispensing piston through the delivery chamber is controlled at least in part based on the sensor output signal.

37. The assembly of claim 35, wherein the sensor output signal is indicative of a pressure in the delivery chamber.

38. The assembly of claim 35, wherein the sensor output signal is indicative of a temperature of the bone cement.

39. The assembly of claim 38, further comprising an output valve in fluid communication with the distal opening of the first body, the output valve controllable based at least in part on the sensor output signal to divert bone cement being dispensed from the delivery chamber into one of a patient delivery lumen and a shunt lumen.

40. The assembly of claim 24, further comprising an output valve in fluid communication with the distal opening of the first body, the output valve controllable to divert bone cement being dispensed from the delivery chamber into one of a patient delivery lumen and a shunt lumen.

41. The assembly of claim 24, further comprising a barrier dividing the chamber into fist and second isolated sections, the first section containing a liquid bone cement component, and the second section containing a solid bone cement component, the barrier of a type that may be broken upon the application of a sufficient force.

42. The assembly of claim 24, further comprising a patient delivery tube in fluid communication with the delivery chamber, the patient delivery tube being permanently fixed to the first body.

43. The assembly of claim 42, wherein the first body and patient delivery tube are formed as a single body structure.

44. The assembly of claim 24, further comprising a patient delivery tube in fluid communication with the delivery chamber, and an integrated cooling system for cooling one or both of the delivery chamber and patient delivery tube.

45. Apparatus for mixing and dispensing a multi-component bone cement, comprising:
a first body forming a delivery chamber;
a second body connectable to the first body, the second body forming a mixing chamber, the second body having a proximal opening in communication with the mixing chamber, at least a portion of the delivery chamber extending from the proximal opening having a substantially uniform cross-section;
an intra-chamber valve for selectably placing the mixing chamber in communication with the delivery chamber when the second body is connected to the first body; and
a mixing assembly, the mixing assembly including
a mixing rod having a distal end extending into the mixing chamber,
a mixing element attached to the mixing rod distal end, and
a mixing chamber ejection piston having an outer periphery sized to substantially seal the proximal opening of the mixing chamber while allowing the piston to be moved distally through the mixing chamber, the piston having an opening through which the rod extends.

46. The assembly of claim 45, further comprising a stop selectively positioned on the mixing rod for engaging and moving the mixing chamber ejection piston as the mixing rod is moved distally through the mixing chamber.

47. The assembly of claim 46, the stop comprising an elastic ring that forms an interference fit around the mixing rod.

48. The assembly of claim 45, the stop comprising a locking member that may be fixed on the mixing rod with a screw.
